(19) United States
(12) Patent Application Publication
(10) Pub. No.: US 2019/0274242 A1
(43) Pub. Date: Sep. 12, 2019

(54) SEED CRACKER THREADED FOR PRECISE APPLICATION OF FORCE

(71) Applicant: Jason Lee Hilton, Springdale, AR (US)

(72) Inventor: Jason Lee Hilton, Springdale, AR (US)

(21) Appl. No.: 16/295,831

(22) Filed: Mar. 7, 2019

Related U.S. Application Data
(60) Provisional application No. 62/639,851, filed on Mar. 7, 2018.

(51) Int. Cl. A01C 1/02; B02C 1/00

(52) U.S. Cl. CPC A01C 1/02; B02C 1/00

(57) ABSTRACT

A shell cracking tool is provided. The shell cracking tool has first portion with a sequential arrangement of a threaded portion, a visible trough and a block surface. The second portion of the tool provides shaft dimensioned and adapted to operatively associate with the threaded portion so that an operational end of the shaft compresses a seed in the trough against the block surface. Thereby, the shell cracking tool selectively urges cracks in the shell of a seed that this visible in the trough, to the point where the slightly cracked shell is more likely to germinate as compared to its pre-cracked state.

### CROSS-REFERENCE TO RELATED APPLICATION

This application claims the benefit of priority of U.S. provisional application No. 62/639,851, filed 7 Mar. 2018, the contents of which are herein incorporated by reference.

### BACKGROUND OF THE INVENTION

The present invention relates to horticulture and, more particularly, a shell cracking tool threaded for the precision application of force for the purpose of selectively urging one or more small crack along the shell to aid germination of the seed therein.

Some seeds have a very hard shell, so that it would be helpful to their germination if they were partially, but not fully, cracked open before germination. Unfortunately, current options for cracking shells are nut crackers or glorified scissors. These options do not offer selective control of the force they exert on the shell, which is problematic because successful germination requires only small cracks in the shell, not its shattering. Such a task requires precision in the urging of small cracks in the shell, as opposed to cracking the shell completely and wide open (for obtaining access to the kernel or nut meal for eating purposes). When using current nut crackers, squeezing by hand, the shell will be too cracked and it is possibly that the seed will be crushed before the user can stop after only pre-cracking. Scissors can crush the seed too.

As can be seen, there is a need for a shell cracking tool threaded for precision application of force for the purpose of selectively urging small crack along the shell to aid germination of the seed therein. The tool includes first portion having a sequential arrangement of a threaded portion, a trough and a block surface. The second portion of the tool provides shaft operatively associated with the threaded portion so that an operational end of the shaft compresses a seed in the trough against the block surface. Thereby, the shell cracking tool selectively urges cracks in the shell of a seed that this visible in the trough, to the point where the slightly cracked shell is more likely to germinate as compared to its pre-cracked state. The screw-like selective manner in which the shell cracking is performed, allows for micro adjustment, and so prevents excessive damage to and/or crushing of the shell and seed.

### SUMMARY OF THE INVENTION

In one aspect of the present invention, a shell cracking tool including the following: a first portion having a handle and a shaft; the shaft providing a threaded portion and a distal operational end; and a second portion providing a sequential arrangement of a threaded bore, a trough, and a block surface, respectively; the threaded bore dimensioned to operatively associate with said threaded portion so that the operational end is selectively movable across a supporting surface of the trough toward and away from the block surface, wherein the supporting surface is visible between the operational end and the block surface.

In another aspect of the present invention, the shell cracking tool includes the following: a first portion having a handle and a shaft; the shaft providing a sequential arrangement of a threaded portion, a non-threaded portion, and a distal operational end, respectively; a first conic cavity along the block surface; and a second portion providing a sequential arrangement of a threaded bore, a trough, and a block surface, respectively; the threaded bore dimensioned to operatively associate with said threaded portion so that the operational end is selectively movable across a supporting surface of the trough toward and away from the block surface, wherein the supporting surface is generally half-circular in shape having a diameter between one-eighth inch and one-quarter and a length of approximately between ⅜ and ⅝ inch wherein the supporting surface is visible between the operational end and the block surface, wherein the trough and the threaded bore are concentric and the trough as a smaller diameter; and a second conic cavity along the operational end so that the first and second conic cavities align when the threaded portion operatively associates with the threaded bore.

In yet another aspect of the present invention a method of cracking a shell of a seed to improve odds of germination of the seed includes the following: providing the above-mentioned shell cracking tool; placing a seed in the trough; operatively associating the threaded portion with the threaded bore; and selectively sandwiching the seed between the block surface and the operational end by rotating the first portion relative to the second portion.

These and other features, aspects and advantages of the present invention will become better understood with reference to the following drawings, description and claims.

### BRIEF DESCRIPTION OF THE DRAWINGS

FIG. 1 is a bottom perspective view of an exemplary embodiment of the present invention;

FIG. 2 is an enlarged perspective view of an exemplary embodiment of the present invention, taken along line 2 in FIG. 1;

FIG. 3 is a top perspective view of an exemplary embodiment of the present invention;

FIG. 4 is an enlarged perspective view of an exemplary embodiment of the present invention, taken along line 4 in FIG. 3;

FIG. 5 is a bottom perspective view of an exemplary embodiment of the present invention;

FIG. 6 is an elevation view of an exemplary embodiment of the present invention;

FIG. 7 is an elevation view of an exemplary embodiment of the present invention;

FIG. 8 is a perspective view of an exemplary embodiment of the present invention;

FIG. 9 is an elevation view of an exemplary embodiment of the present invention; and

FIG. 10 is an elevation view of an exemplary embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a shell cracking tool having first portion with a sequential arrangement of a threaded portion, a visible trough and a block surface. The second portion of the tool provides shaft dimensioned and adapted to operatively associate with the threaded portion so that an operational end of the shaft compresses a seed in the trough against the block surface. Thereby, the shell cracking tool selectively urges cracks in the shell of a seed that this visible in the trough, to the point where the slightly cracked shell is more likely to germinate as compared to its pre-cracked state. The screw-like selective manner in which the shell cracking is performed, allows for micro adjustment, and so prevents excessive damage to and/or crushing of the shell and seed.

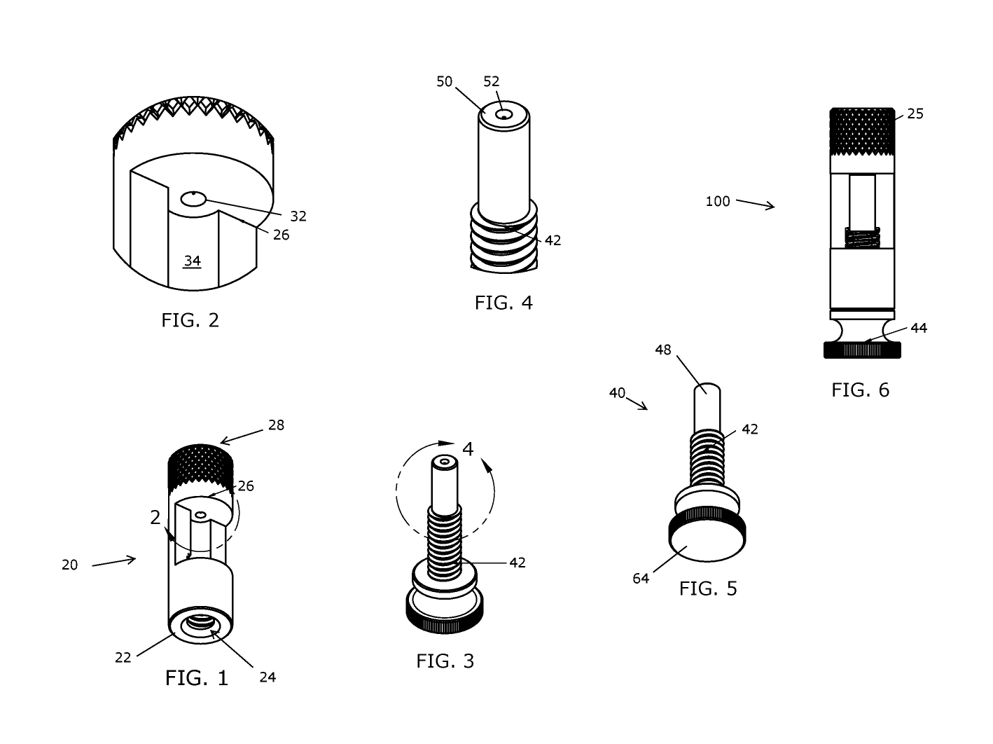

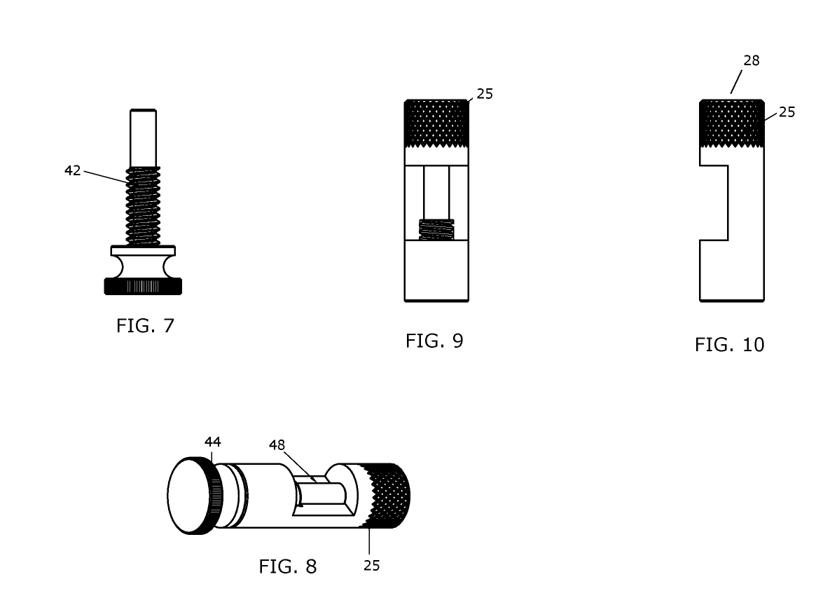

Referring now to FIGS. 1 through 10, the present invention may provide a shell cracking tool 100 providing a block member 20 dimensioned and adapted to operatively associate with a compression portion 40, wherein the block member 20 provides a trough 30 dimensioned and adapted to accommodate a seed (not shown).

The block member 20 extends from a bore end 22 and a block end 28 provides a threaded bore 24 that communicates to a trough 30, the trough 30 extends from the threaded bore 24 to a block portion 26 provided by the block member 20. The trough 30 being approximately the same diameter as the threaded bore 24, through the trough 30 being a half a circle as opposed to the full circle of the threaded bore 24. The “missing” half, so to speak, enables the trough 30 to be visible during the extent of its operation, thereby any seed (not shown) lain in the trough 30 is visible while the seed shell is being cracked. This is important (and different from much of the prior art) as this visibility allows the user to see when a sufficient (and slight) amount of “pre-cracking” has been selectively achieved, and halt the process accordingly.

The block portion 26 may be a flat surface with a first conic cavity 32, wherein the first conic cavity 32 may be centered at what would be the center of the threaded bore 24 and the trough 30 if the trough 30 was a full circle (see above). The block end 28 may provide a knurl grip 25 for facilitating the rotational/screw operation of the shell cracking tool 100.

The compression portion 40 may extend from a handle portion 64 to an operational end 50. The operational end 50 may be a flat surface with a second conic cavity 52, wherein the second conic cavity 52 may be centered at what would be the center of the threaded bore 24 when the compression portion 40 is operatively associated therewith. And as a result, the first and the second conic cavities 32 align during operation.

The handle portion 64 may provide a knurl grip 44 for facilitating the operation of the shell cracking tool 100. Extending from the handle portion 64 is a shaft 46 having a threaded portion 42 and a distal non-threaded portion 48. The threaded portion 42 is dimensioned and adapted to operatively associate with the threaded bore 24. The non-treaded portion 48 is dimensioned and adapted to slide through the threaded bore 24 (because of the lesser diameter of the non-threaded portion 48) and slide along the supporting surface 34 of the trough 30 (as a corollary the diameter of the trough 30 may be smaller than the overall diameter of the threaded bore 24) yet offset so their centers generally align.

A method of using the present invention may include the following. The seed cracking tool 100 disclosed above may be provided. A user may slide the operational end 50 through the threaded bore 24 until the threaded portion 42 of the shaft 46 engages the threading of the threaded bore 24. The user may place a seed onto the supporting surface 34 of the trough 30. Then the user may selectively engage said threaded portion and bore by gripping and/or rotating the knurled grips 25 and 44 until the operational end 50 urges the seed against the block portion 26 so that pre-cracking or cracking occurs along the shell's surface. The non-threaded portion being slidably disposed and guided through the threaded bore 24 in an adjustable and stable manner because of the threading. The selective and controlled nature of the screwing operation along with the visibility of the trough 30 enables the user to selective form a predetermined amount of cracking in the shell, and stop the resulting compressive force before there is over-cracking.

In certain embodiments, opposing elements, possibly pointed elements of the seed, can be received in the first and second conic cavities 32 and 52, respectively, which may facilitate the selective pre-cracking/slight cracking of the shell. After the predetermined amount of pre-cracking is obtained, the seed would be ready for germination.

When not in use, the compression portion 40 may be screwed until the operational end 50 and the block portion 26 abut in a stored condition, as illustrated in FIGS. 6 and 8.

It should be understood, of course, that the foregoing relates to exemplary embodiments of the invention and that modifications may be made without departing from the spirit and scope of the invention as set forth in the following claims.

What is claimed is:

1. A shell cracking tool, comprising:
a first portion having a handle and a shaft;
the shaft providing a threaded portion and a distal operational end; and
a second portion providing a sequential arrangement of a threaded bore, a trough, and a block surface, respectively;
the threaded bore dimensioned to operatively associate with said threaded portion so that the operational end is selectively movable across a supporting surface of the trough toward and away from the block surface,
wherein the supporting surface is visible between the operational end and the block surface.

2. The shell cracking tool of claim 1, wherein the supporting surface is dimensioned to support a seed.

3. The shell cracking tool of claim 1, wherein the supporting surface is generally half-circular in shape having a diameter between one-eighth inch and one-quarter inch and a length of between ⅜ inch and ⅝ inch.

4. The shell cracking tool of claim 1, wherein the handle provides a first knurl surface grip.

5. The shell cracking tool of claim 1, wherein the second portion provides a distal portion having a second knurl surface grip.

6. The shell cracking tool of claim 1, wherein the shaft has a non-threaded portion between the operational end and the threaded portion.

7. The shell cracking tool of claim 1, wherein the trough and the threaded bore are concentric and the trough has a smaller diameter than the threaded bore.

8. The shell cracking tool of claim 1, further comprising a first conic cavity along the block surface; and a second conic cavity along the operational end so that the first and second conic cavities align when the threaded portion operatively associates with the threaded bore.

9. A shell cracking tool, comprising:
a first portion having a handle and a shaft;
the shaft providing a sequential arrangement of a threaded portion, a non-threaded portion, and a distal operational end, respectively;
a first conic cavity along the block surface; and
a second portion providing a sequential arrangement of a threaded bore, a trough, and a block surface, respectively;
the threaded bore dimensioned to operatively associate with said threaded portion so that the operational end is selectively movable across a supporting surface of the trough toward and away from the block surface, wherein the supporting surface is generally half-circular in shape having a diameter between one-eighth inch and one-quarter inch and a length of between ⅜ inch and ⅝ inch, wherein the supporting surface is visible between the operational end and the block surface, wherein the trough and the threaded bore are concentric and the trough as a smaller diameter; and
a second conic cavity along the operational end so that the first and second conic cavities align when the threaded portion operatively associates with the threaded bore.

10. A method of cracking a shell of a seed to improve odds of germination of the seed, comprising:
providing the shell cracking tool of claim 1;
placing a seed in the trough;
operatively associating the threaded portion with the threaded bore; and
selectively sandwiching the seed between the block surface and the operational end by rotating the first portion relative to the second portion.
